(19) United States
(12) Patent Application Publication
(10) Pub. No.: US 2026/0227196 A1
(43) Pub. Date: Aug. 6, 2026

(54) TRAFFIC PATTERN RECOGNITION FOR ACCURATE TRAVEL TIME PREDICTION

(71) Applicant: Walmart Apollo, LLC, Bentonville, AR (US)

(72) Inventors: Harsha Chetty, Centerton, AR (US); Lakshmi Prasad Rayudu Abbireddy, Rajahmundry (IN); Prabhat Kumar Diwaker, Bangalore (IN); Sandhya Raghavan, Bangalore (IN); Akash Choudhury, Bengaluru (IN); Hossein Hashemi, Plano, TX (US); Ravi Kumar Batchu, Bengaluru (IN); Manjeet Singh, Bengaluru (IN); Toshi Prakash, Bangalore (IN); Shikhar Jain, Bengaluru (IN); Anand Rajneesh, Bengaluru (IN)

(21) Appl. No.: 19/042,068

(22) Filed: Jan. 31, 2025

(51) Int. Cl. G01C 21/36; G08G 1/01; G08G 1/052

(52) U.S. Cl. CPC G01C 21/3691; G01C 21/3492; G08G 1/0112; G08G 1/0129; G08G 1/052

(57) ABSTRACT

Examples provide a traffic pattern recognition for accurate pixel-level travel time prediction. Historical travel-related data is obtained from vehicles traveling within various geographic regions that includes location data and speed data associated with each pixel in a plurality of pixels at a month, day, and hour level. A trained machine learning (ML) model predicts the speed of travel through each pixel at a weekday-hour-pixel (WHP) level. The ML model is trained using the historical travel-related data enabling the ML model to make accurate predictions of future travel times at the WHP level. The predicted speeds of travel are used to create a table of speed values for multiple pixel-timeslots associated with future dates. Each pixel-timeslot includes a predicted speed value for vehicles traveling through segments of each node on a given future data during a specific hour of the day enabling more accurate estimations of arrival time.

### BACKGROUND

In a last mile delivery ecosystem, a trip planner plays an important role in efficiently batching order deliveries together and planning order delivery trips. Predicting accurate planned trip time is important for the trip planner to be able to create batches, select delivery routes and plan trips. Traffic conditions may not be considered while calculating the trip time. This results in higher trip time variance and the trip planner overestimating or underestimating the planned trip time, which negatively impacts on-time delivery (OTD).

### SUMMARY

Some examples provide a system and method for generating accurate pixel-specific travel time. Historical travel-related data associated with a plurality of vehicles traveling within a geographic region is obtained. The historical travel-related data includes location data and speed data associated with each pixel in a plurality of pixels at a month, day, and hour level. Each pixel representing a unique sub-region division of the geographic region. A single speed value at a weekday-hour-pixel (WHP) level is generated for each pixel in the plurality of pixels, by a trained machine learning (ML) model using the historical travel-related data. The ML model is trained to generate a predicted speed of travel through the plurality of pixels at the month, day, and hour level. A speed values table is created that includes a plurality of pixel-timeslot speed values for a plurality of future dates, a pixel-timeslot speed value in the plurality of pixel-timeslot speed values comprising a predicted speed of travel along a node through a selected pixel at a future date and within a selected hour of the future date. The speed values table is stored in a data storage device. The speed values in the speed values table are utilized by a mapping application to predict speeds to traverse one or more nodes between a point of departure and a destination at WHP level.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts an example block diagram illustrating a system for generating future speed values at a weekday-hour-pixel (WHP) level;

FIG. 2 depicts an example block diagram illustrating a system for generating a speed values table including future pixel-timeslot speed values.

FIG. 3 depicts an example block diagram illustrating a travel data manager for generating accurate future speed values at a weekday, hour, and per-pixel level.

FIG. 4 depicts an example block diagram illustrating a mapping application for generating more accurate travel time predictions using predicted speed values at a WHP level.

FIG. 5 depicts an example block diagram illustrating a route comprising a plurality of nodes through a plurality of pixels.

FIG. 6 is an example flow chart illustrating operation of the computing device to use predicted future speed values at a pixel-level and estimated times of arrival (ETAs) to plan trips.

FIG. 7 is an example flow chart illustrating operation of the computing device to generate predicted speed values at a WHP level using historical travel-related data for a geographic region.

FIG. 8 is an example flow chart illustrating operation of the computing device to generate historical travel-related data from raw travel data.

FIG. 9 is an example flow chart illustrating operation of the computing device to aggregating and filtering historical travel-related data.

FIG. 10 is an example flow chart illustrating operation of the computing device to filter raw travel-related data obtained from a plurality of vehicles.

FIG. 11 depicts an example of a table of predicted speed values and estimated travel times for a plurality of road segments associated with a plurality of pixels representing portions of a geographic region.

FIG. 12 depicts an example of a line graph representing travel time accuracy using predicted speed values at a WHP level versus travel time accuracy using static average speed values.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Many stores utilize drivers to deliver millions of orders from stores to customers. It is desirable to have precise and predictable travel time from the store to the customer's location to select the store closest to the customer for sourcing orders, strategically plan efficient and cost-effective batches and routes for drivers, and ensure a positive driver experience. On-time delivery (OTD) to customers is a measure of success for retailers as well as for carriers. The ability to estimate the trip time is limited during the planning stage, and this has a negative impact on the OTD performance. For instance, if there are three grocery orders that need to be delivered between ten and eleven in the morning and the estimated trip time is calculated as forty-five minutes, there is a possibility that the actual trip may take an hour or more. In this situation, the orders will likely arrive after the promised delivery time slot. This issue can be attributed to the use of outdated mapping systems, failure to consider traffic patterns which fluctuate depending on the time of day and day of the week, as well as an absence of dynamically adjustable speed variables.

In an example scenario, if the maximum time allowed for a grocery delivery trip is thirty minutes, the trip planner forms batches for each trip in a way that the combined travel time for delivering multiple orders to multiple customers (it can be in two or three order batches) does not surpass the allotted thirty minutes. In such cases, it is essential for the Planner to obtain the latest traffic estimates from the mapping application, so that it can batch the right number of orders without compromising OTD. However, mapping applications are typically dependent on an obsolete mapping system that contains traffic data from more than even years old. Furthermore, the traffic information provided by current systems may not update in real-time. The projected travel time to a given store remains unchanged regardless of whether it is a calm Sunday morning at eight in the morning or a weekday at four in the afternoon during rush hour.

Trip planner systems may not apply accurate consideration of delivery vehicle speed where the maximum speed limit is the default speed used for any given path/street. These systems frequently fail to account for traffic, intersections, stop lights, changing traffic conditions at different times of day, etc. There is further a lack of dynamically adjustable speed variables (van speed discounts) with a traffic proxy, currently at store and day level, as well as using outdated open street based maps with fixed speed values across all hours. This results in high trip time variance and planner systems that overestimate or underestimate the planned trip time resulting in inaccurate estimated delivery times and failure to consistently provide on-time delivery OTD of orders.

Current systems may frequently rely on static and outdated traffic information for planning last mile deliveries. Many mapping and routing engines are designed to find the shortest paths in road networks. These systems typically leverage a static outdated master database which has distance and single speed value between nodes. This results in inefficiently planned trips which may arrive late with respect to actual delivered time, leading to higher delivery costs in cases of over-estimating travel time and customer dissatisfaction where travel time is under-estimated. These inaccuracies and inefficiencies can result in delivery of only a single order to ensure OTD when more orders could have been delivered within the same trip duration; late deliveries, poor driver experience, low confidence for promised delivery times, customer dissatisfaction, and frustration for both drivers as well as customers.

Referring to the figures, examples of the disclosure enable generation of predicted speed values at a weekday, hour, and pixel (WHP) level for more accurate travel time predictions with traffic pattern recognition. In some examples, a trained machine learning (ML) model utilizes historical travel-related data including pixel-level historical speed values associated with each pixel in a plurality of pixels representing a plurality of sub-regions within a geographic region. The ML model generates predicted future speeds for each pixel at a month, day, and hour level. The predicted speed values are stored in a speed values table for utilization in calculating predicted travel times for road segments between nodes in a route with greater accuracy and reliability. This enables more accurate estimated time of arrival (ETA) predictions for orders and more efficient trip planning for delivery orders to multiple customers.

Aspects of the disclosure further enable a trained ML model for calculating predicted speeds at which a vehicle is likely to travel along a route or portion of a route associated with one or more pixels at a month, day of the week, and hour level for each pixel. The computing device operates in an unconventional manner by utilizing historical travel time data for the same day of the week in previous months for calculating more accurate predicted speed values for future dates occurring on the same day of the week. In this manner, the computing device is able to predict actual speeds occurring more accurately on specific dates and during specific hours of the day within specific portions of a planned route while further reducing errors in expected arrival times, and allows more efficient delivery planning, more accurate ETA calculations, and an increased number of on-time deliveries. Because fewer errors occur during trip planning as a result of the more accurate predicted speed values along various planned routes, fewer resources are consumed, such as reduced memory usage storing less-reliable static average speed data and reduced processor usage calculating trip times without accurate speed data for vehicles traveling along a given route on a given day and time. This reduces system resource usage as well as improves user efficiency via the UI interface providing the more accurate predicted travel time data for increased user interaction performance, thereby improving functioning of the underlying computing device.

In other embodiments, a mapping application is provided which utilized the ML model generated speed predictions to calculate more accurate travel time between nodes associated with one or more pixels on a given future date and future time with fewer errors in the predicted travel times. The accurate travel time data enables an increased number of deliveries to be scheduled together for delivery by a single driver, thereby reducing delivery times across multiple deliveries, reducing fuel consumption by the delivery vehicles, and further improving customer satisfaction by reducing delays in order delivery. The system further enables an increased number of deliveries to be carried out by fewer delivery drivers for reduced delivery vehicle usage, reduced order delivery costs, and reduced network bandwidth usage consumed where fewer delivery drivers and delivery vehicles are required for delivery orders where more accurate travel times enable consolidation of larger number of orders together for delivery by a single delivery vehicle making multiple stops along a single route from a store (point of departure) to two or more delivery destinations associated with two or more customer orders.

The ML model, in some embodiments, effectively addresses the challenges of accurate travel time prediction along a given route by accurately predicting trip durations at a day and hour level. This enables the system to plan trips realistically, resulting in improving the OTD metric. The system enables accurate and timely delivery of orders for greater efficiency and enhanced overall customer experience.

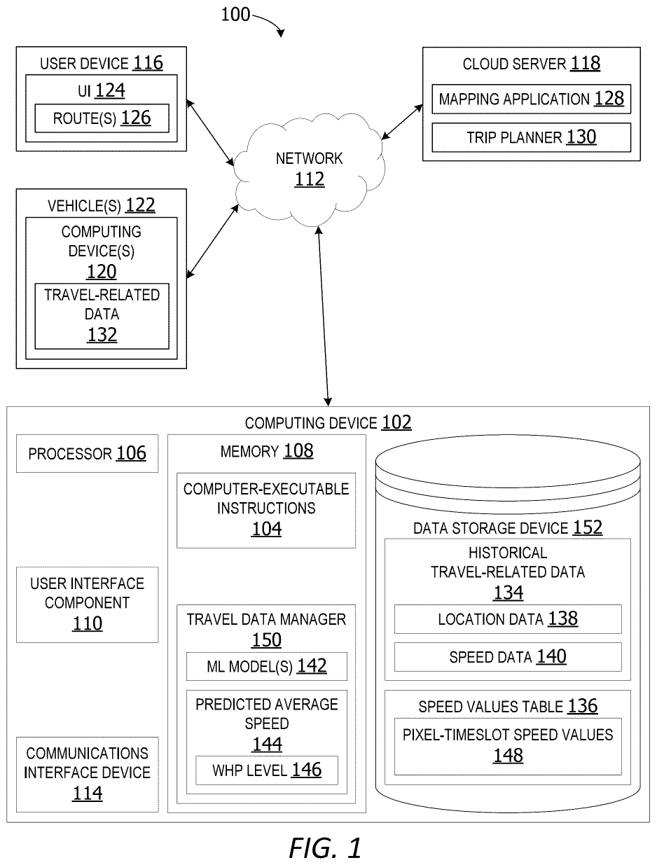

Referring again to FIG. 1, an example block diagram illustrates a system 100 for generating future speed values at a weekday-hour-pixel (WHP) level. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

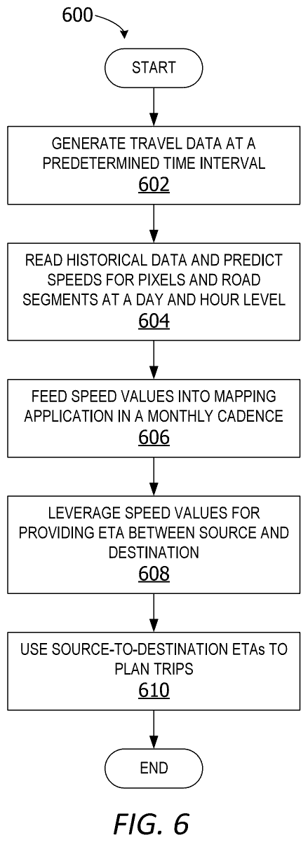

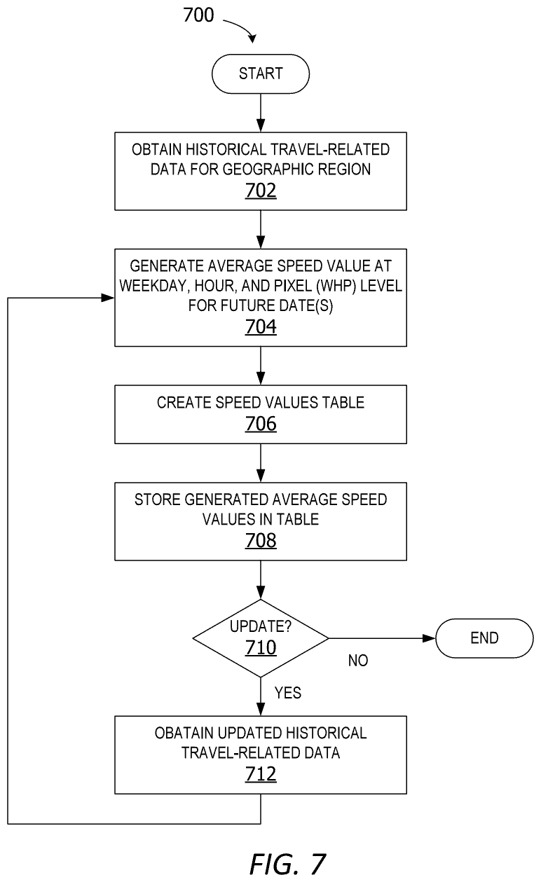

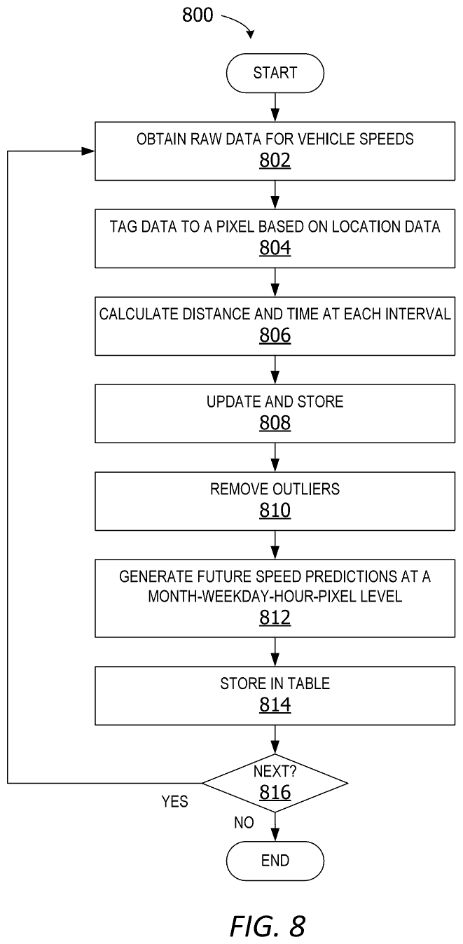

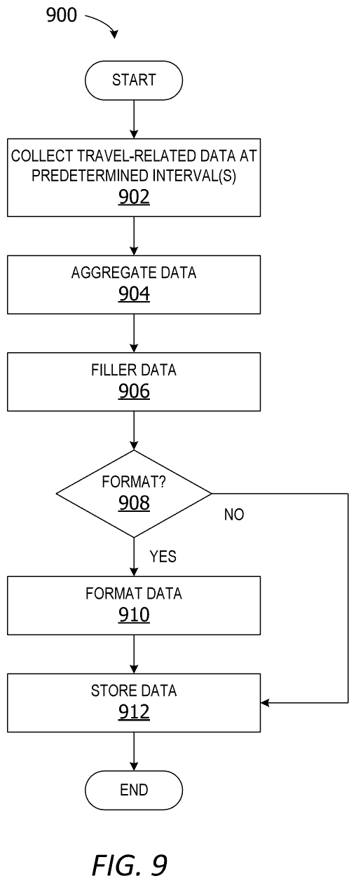

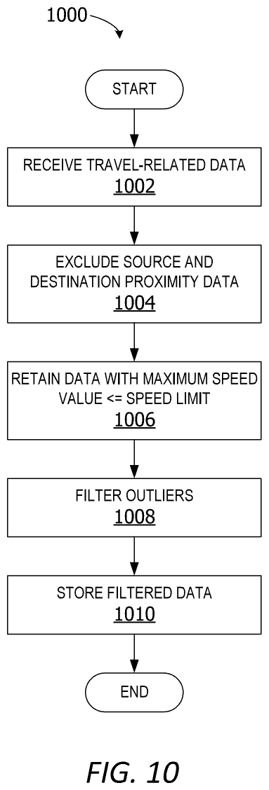

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 6, FIG. 7, FIG. 8, FIG. 9, and FIG. 10).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116, cloud server 118, and/or one or more other computing device(s) 120 associated with one or more delivery vehicle(s) 122, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) 124. The UI 124 is a user interface device, such as, but not limited to, the user interface device 110. The UI 124 surfaces data to one or more users, such as, but not limited to, one or more travel route(s) 126. The one or more route(s) 126 includes a route along a roadway or other way of travel, such as a bridge, highway, freeway, etc.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The cloud server 118 optionally hosts one or more applications, such as, but not limited to, a mapping application 128 and/or a trip planner 130. The mapping application 128 is an application for identifying or generating route(s) 126 of travel from a point of departure to a destination. The trip planner 130 is an application for planning a delivery route or trip including one or more destinations associated with delivery orders. The trip planner 130 determines how many orders within a given area can be delivered within an allocated delivery time by a single delivery vehicle.

The computing device(s) 120 include one or more devices for generating travel-related data 132 associated with one or more delivery vehicle(s) 122. The computing device(s) 120 can include a mobile computing device such as a smartphone or tablet. The computing device(s) 120 can also include a computing device integrated into a vehicle, such as an on-board computing device. The computing device(s) 120 include at least one processor, memory, and/or communications interface device.

The system 100 can optionally include a data storage device 152 for storing data, such as, but not limited to, historical travel-related data 134 and/or speed values table 136. Historical travel-related data 134 is travel data obtained from one or more vehicle(s) 122, including location data 138 and/or speed data 140. The location data 138 includes data associated with a vehicle on a given date and at a given time. The location data 138 includes any type of data for identifying a location of a vehicle, such as, but not limited to, location coordinates. Location coordinates includes latitude and longitude coordinates. Location coordinates can also include global positioning system (GPS) coordinates.

Speed data 140 is data associated with a speed of a vehicle at a given time or a speed of a vehicle during a predetermined period of time. The speed data 140 can be measured in miles per hour (MPH), kilometers per hour (KPH), or any other type of speed measurement.

In some embodiments, the location data 138 and/or the speed data 140 is generated using raw travel-related data 132 obtained from the one or more computing device(s) 120 associated with the vehicle(s) 122. In some embodiments, the raw travel-related data 132 is obtained from the vehicle(s) 122 at regular intervals. The raw travel-related data 132 is filtered to remove outliers and other extraneous information. The filtered data is then used to generate the location data 138 and/or the speed data 140.

In other embodiments, the location data 138 and speed data 140 is collected regularly from vehicles traveling throughout a given geographic region for an extended period of time, such as one or more months. In other embodiments, the raw travel-related data 132 is collected for one or more years. The collected data is filtered and otherwise processed and used to generate the historical travel-relate data 134, which is used to train one or more machine learning (ML) model(s) 142 to generate predicted speed 144 of a vehicle traveling along a portion of a given route at a weekday, hour, and pixel (WHP) level.

In some embodiments, the ML model(s) 142 utilize the historical travel-related data 134 to generate a plurality of predicted speed values, such as, but not limited to, the predicted speed 144. Each predicted speed 144 at the WHP level 146 represents a speed value predicted for vehicles traveling through a specific pixel in a plurality of pixels representing the geographic region. The ML model(s) 142 generate a predicted speed for each pixel in the plurality of pixels for each hour in each twenty-four hour day in a given future time-frame, such as a future month. The predicted speeds are used by a travel data manager 150 to create a speed values table 136 including a plurality of pixel-timeslot speed values 148.

The speed values table 136, in some embodiments, is a table including a pixel-timeslot for every hour in a given future time-period. A pixel-timeslot is a table record for a predicted speed of vehicles traveling through a given pixel during a given hour on a future day of a future week and/or a future month.

For a future month of thirty-one days, there are 744 hours. In this example, the speed values table 136 includes 744 pixel-timeslots for each unique pixel in a plurality of pixels representing a given geographic region. If only three pixels represent a given region, the speed values table 136 would include 744 pixel-timeslot speed values for each of the three pixels, resulting in a total of 2,232 pixel-timeslot speed values. Likewise, if a future month includes only twenty-eight days, the table includes 672 hours. The table representing a region having three pixels would include 2,016 pixel-timeslot values. However, the embodiments are not limited to a region having three pixels. The embodiments include geographic regions having any number of sub-region divisions represented by any number of pixels. For example, a plurality of pixels associated with a speed values table can include dozens of pixels, hundreds of pixels, as well as thousands of pixels.

The data storage device 152 can include one or more different types of data storage devices, such as, for example, one or more rotating disks drives, one or more solid state drives (SSDs), and/or any other type of data storage device. The data storage device 152 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 152 includes a database.

The data storage device 152 in this example is included within the computing device 102, attached to the computing device, plugged into the computing device, or otherwise associated with the computing device 102. In other examples, the data storage device 152 includes a remote data storage accessed by the computing device via the network 112, such as a remote data storage device, a data storage in a remote data center, or a cloud storage.

The memory 108 in some examples stores one or more computer-executable components, such as, but not limited to, a travel data manager 150. The travel data manager 150, when executed by the processor 106 of the computing device 102, obtains the historical travel-related data 134 associated with the one or more vehicle(s) 122 traveling within a geographic region during past dates and/or times. The historical travel-related data 134 is associated with each pixel in a plurality of pixels at a weekday, hour, and pixel (WHP) level 146. The WHP level refers to speed and location data obtained from the vehicle(s) 122 at a granularity of weekdays, hours, and pixels. A weekday includes days in a seven day week, including Sunday, Monday, Tuesday, Wednesday, Thursday, Friday, and Saturday.

In other embodiments, the historical travel-related data 134 includes data at a month, weekday, hour, and pixel (MWHP) level. The MWHP level refers to location and speed data for vehicles associated with a specific month, specific days of a seven day week, and specific hours in each day for each pixel in the plurality of pixels. For example, the historical travel-related data 134 would include speed data for vehicles traveling through a sub-region division represented by a unique pixel on a specific date within the month identified with both the day of the month as well as the day of the week and the hour within a twenty-four hour day in which the vehicle was traveling.

In some embodiments, the travel data manager 150, including one or more ML model(s) 142, generates a predicted speed value at the WHP level 146 for each pixel in the plurality of pixels representing the geographic region. The ML model(s) 142 are trained to generate predicted speed values for likely speed of travel at the month, day, and hour level.

The travel data manager 150 accounts for differences in travel patterns occurring on different days of the week and during different months and seasons of the year. For example, the travel data manager 150 can predict that the most likely speed for a given pixel on a Wednesday morning at eight o'clock in March is likely to be twenty miles per hour while a predicted speed value for the same pixel on a Wednesday at 8 o'clock in the morning in July is likely to be thirty-five miles per hour due to differences in traffic patterns in different months. Likewise, the travel data manager 150 may predict that speed through a given sub-region represented by a pixel is thirty miles per hour at four o'clock on Friday but is likely to be fifty miles per hour at four o'clock on a Sunday due to different traffic patterns on weekends than on other days of the week.

In some embodiments, the travel data manager 150 creates a speed values table 136 including pixel-timeslot speed values 148 for a plurality of future dates, a pixel-timeslot speed value in the plurality of pixel-timeslot speed values comprising a predicted speed of travel along a node through a selected pixel at a future date and within a selected hour of the future date. A node is a smallest unit of a map or geographic region. A node can include any type of unit or reference marker for marking a beginning or ending of a road segment, such as an intersection, a mile marker, a road merger, etc. Two or more nodes define a way or portion of a way including one or more road segments.

The speed values table 136 is stored in the data storage device 152 for utilization by mapping applications, such as, but not limited to, the mapping application 128. Mapping applications can utilize predicted speed values for specific dates, times, and locations provided in the table to determine travel time from a source (point of departure) to a destination. The speed values table are utilized by a mapping application to predict speeds to traverse a plurality of nodes between a point of departure and a destination at WHP level. These speed values along with distance data are used to predict the travel time. For example, if the distance is five miles at a predicted speed of twenty miles per hour, the mapping application can predict that the travel time to travel the five miles is likely to be fifteen minutes. In some embodiments, the mapping application determines the distance for a route or portion of a route using one or more mapping algorithms. The trip planner 130 utilizes the distance data and the predicted travel times generated by the mapping application to generate one or more route(s) 126 to be taken by a delivery driver delivering orders to one or more customer locations, such as a customer residence or other location.

In this example, the mapping application 128 and/or the trip planner 130 are located on a cloud server 118. However, in other embodiments, the trip planner 130 and/or the mapping application 128 are located on the same computing device 102 with the travel data manager 150. Likewise, the travel data manager 150 is not limited to implementation on a computing device. In other embodiments, the travel data manager 150 is located on a cloud server, such as, but not limited to, the cloud server 118.

In some embodiments, the system leverages data collected from last mile tracking (LMT) platform for computing accurate and dynamic (hourly) traffic predictions. The LMT platform is associated with the one or more computing device(s) 120 associated with the one or more vehicle(s) 122. The LMT platform enables collection of raw travel-related data from the one or more vehicle(s) 122 in almost real-time. In this example, the raw travel-related data is collected at thirty second intervals. However, the embodiments are not limited to a thirty second interval to collect data. In other embodiments, any user-configured interval can be employed to pull data from the computing device(s) 120. In other embodiments, the computing device(s) 120 push the data to the data storage device 152 at the occurrence of a predetermined event, such as the regular time interval.

In some embodiments, the travel data manager 150 pings vehicle(s) 122 every thirty seconds to collect travel-related data 132, including latitude, longitude, distance, travel time, and speed. This can result in millions of data points per day. The travel-related data 132, in some embodiments, is analyzed using a hierarchical geospatial indexing system which divides a geographic region into sub-regions. In some embodiments, the pixels are H3 pixels having hexagon and/or pentagon shaped pixels. In these embodiments, the sub-regions can include hexagon-shaped pixels representing sub-region divisions and/or pentagon-shaped pixels representing the sub-region divisions,. The division into hexagon shaped pixels enables effortless location-based indexing, search, and analysis. Each pixel has a unique number assigned to it. These pixels come in different resolutions, such as H6, H7 and H8 having an average area of 36 km², 5 km² and 0.7 km², respectively. In this example, the pixels are hexagon-shaped pixels having H8 resolution.

In other embodiments, the system employs machine learning algorithms to examine the historical travel-related data 134 and construct a traffic model that can accurately forecast the speed of pixels at granularity of 0.7 km². The model's speed predictions will be integrated into the mapping application 128. This solution is cost-effective and scalable. Instead of disrupting the current system, the system is enhanced by generating more accurate and reliable speed predictions at a finer granularity, thereby enriching the existing order delivery infrastructure.

The system 100, in some embodiments, includes one or more ML model(s) 142 trained using historical travel-related data 134 capable of predicting more precise speed values at a day and hourly level. The updated speed values are then incorporated into database tables utilized by the mapping application 128, such as, but not limited to, the speed values table 136. For example, a predicted speed along a road segment can be fifty mph at eight o'clock in the morning but only twenty-five mph along the same road segment a few hours later at eleven o'clock in the morning. This ensures that the routing options reflect the current level of congestion or smooth flow of vehicles on the road. Consequently, it enhances the potential for time-saving routes by avoiding slower and more congested roads.

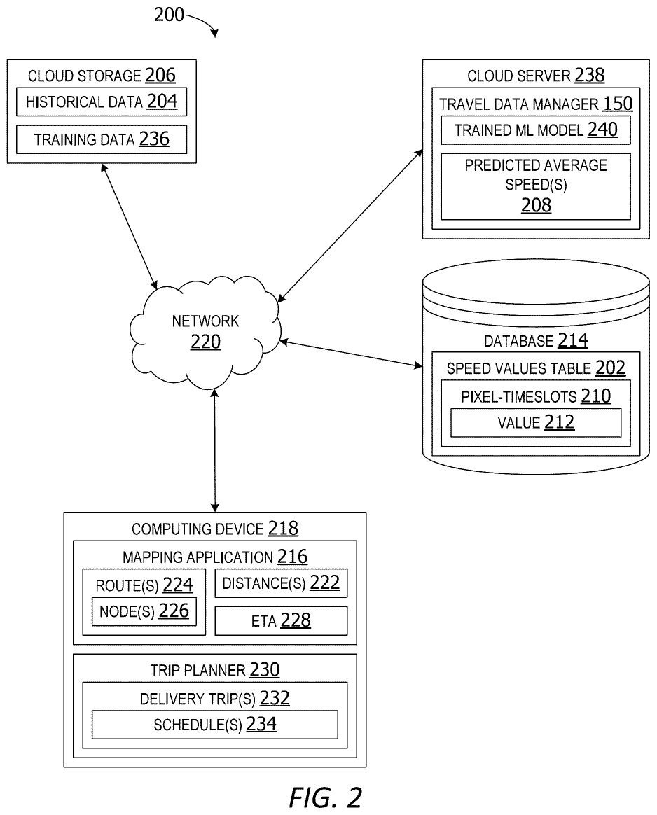

FIG. 2 depicts an example block diagram illustrating a system 200 for generating a speed values table 202 including future pixel-timeslot speed values. In some embodiments, a travel data manager 150 obtains historical data 204 from a data storage, such as, but not limited to, a cloud storage 206. The cloud storage 206 is a data storage associated with a cloud platform, such as, but not limited to, the cloud server 118 in FIG. 1.

The historical data 204 includes historical travel speeds collected from vehicles traveling through a geographic region, such as, but not limited to, the historical travel-related data 134 in FIG. 1. The travel data manager 150 generates predicted speed(s) 208 for a plurality of pixels representing sub-regions of the geographic region. The predicted speed(s) 208 are generated at a month, weekday, and hour level for each pixel and stored in the speed values table 202.

The speed values table 202, in some embodiments, includes a plurality pixel-timeslots 210. Each pixel-timeslot contains a predicted speed value 212 for a given pixel at a month, weekday, and hour level. For example, a predicted speed value can include a predicted speed of thirty miles an hour along a given road segment corresponding to a pixel identifier (ID) identifying a given pixel and within the month of May between three o'clock to four o'clock on Mondays. In this example, the month is May, the weekday is Monday, the hour is three o'clock, and the pixel is the road segment within a sub-region division represented by a pixel having the pixel ID.

The speed values table 202 is stored on a database 214 for access by a mapping application 216 on a computing device 218 or cloud server 238 via a network 220. The computing device 218 is a device, such as, but not limited to, the computing device 102 in FIG. 1. The cloud server 238 is a server associated with a cloud platform, such as, but not limited to, the cloud server 118 in FIG. 1.

The mapping application 216 is any type of mapping application capable of identifying geographic locations on a map using pixel data and/or identifying distance(s) 222 associated with one or more route(s) 224 or portions of route(s) 224 associated with one or more node(s) 226. A node is a reference point or reference marker associated with a road or road segment. A road can include any type of driveway, parkway, highway, freeway, dirt road, multi-lane road, single lane road, bridge, or any other way of travel. The mapping application 216 is a software component for mapping distances and/or generating source-to-destination routes, such as, but not limited to, the mapping application 128 in FIG. 1.

In some embodiments, the mapping application 216 identifies a distance between two or more nodes along a route or portion of a route. The predicted speed values obtained from the speed values table 202 are used by the mapping application and/or a trip planner to predict estimated time of arrival (ETA) 228 of delivery vehicles driving along the route(s) 224.

The trip planner 230 is a component that further utilizes the distance(s) 222, predicted speed(s) 208 and/or the ETA 228 to generate schedule(s) 234 for delivery trip(s) 232 associated with order deliveries. The trip planner 230 is a component for planning trips, such as, but not limited to, the trip planner 130 in FIG. 1.

In some embodiments, the travel data manager 150 includes an ML model, such as, but not limited to, a trained ML model 240. The trained ML model 240 is a ML model trained using training data 236. The training data 236 includes historical travel-related data including recorded travel speeds obtained from vehicles and/or speed values at day of week (weekday), hour and pixel level. In other embodiments, the training data includes historical speed values at a month, day of week, hour, and pixel level.

In some embodiments, the system 200 reads travel-related data associated with delivery vehicle movements data, and predicts accurate speeds at a highly granular format for any given road at a given day and hour. The system leverages historical travel-related data to predict speeds for every pixel for each weekday and hour of a day. The historical data is filtered to remove outliers, such as data associated with driver stoppages near pickup stores, parts of journey where driver walks and serves customers, traffic stops, etc. It figures speeds for pixels where low/no driver data is present by analysing trends across pixels with similar attributes. Since there can be multi-million pixels in a given region, depending on the region size, data tables are utilized to store and preserve distinct information of a pixel.

In some embodiments, the predicted speeds are provided to a mapping application at a fixed monthly cadence. The mapping application has an intelligence to pick up the right speed values depending on the date and time of the order. In one example, the mapping application gets latitude and longitude coordinates for each data point, reads the order timestamp, and reads speeds for the day, hour, and location (geography). The system can handle large scale maps for nations having multiple time zones. Alerts that have been built into the mapping system to identify incorrect speeds, null values, missing input files, etc. The trip planner obtains routes and times from the mapping application to schedule delivery orders.

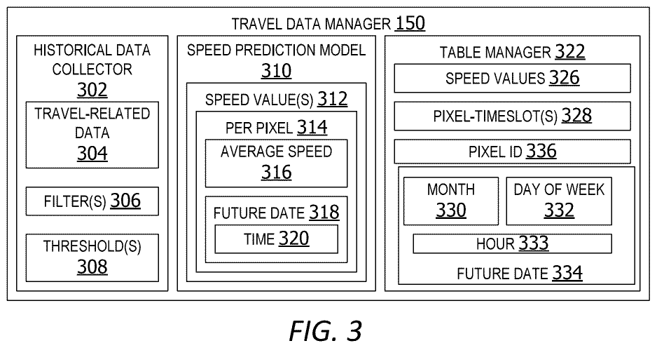

FIG. 3 depicts an example block diagram illustrating a travel data manager 150 for generating accurate future speed values at a weekday, hour, and per-pixel level. A historical data collector 302 is a component which collects raw travel-related data 304 from one or more vehicles for a selected period of time. In some embodiments, the travel-related data includes data collected for months or years. The raw travel-related data 304 is filtered using one or more user-configurable filter(s) 306 and/or using one or more threshold(s) 308.

In some embodiments, the historical data collector 302 filters outlier speed values, such as, but not limited to, speed values collected from vehicles that exceed a posted speed limit for the road segment or other location at which the speed value is generated. In other embodiments, the historical data collector 302 removes speed values that fall below a minimum speed threshold. In still other embodiments, the historical data collector removes raw travel-related data showing a vehicle remaining stationary for a threshold maximum time. This enables the system to remove outliers and speed data which is not representative of actual speeds of vehicles traveling within a given sub-region.

In some embodiments, a speed prediction model 310 is a ML model trained to generate predicted speed value(s) 312 at a per-pixel 314 level. The predicted speed 316 is predicted for a future date 318 and time 320. The time 320 is a time at an hourly level. The future date 318 can include a month 330, day of week 332, and/or hour 333. The weekday level includes a day of the week. The days of the week include the seven days of Sunday through Saturday.

A table manager 322, in some embodiments, generates a table of predicted speed values, such as, but not limited to, a speed values table 136 in FIG. 1. The table manager 322 populates the table with the predicted speed values 326 generated by the trained speed prediction model 310. The speed values are recorded in one or more pixel-timeslot(s) 328 containing a predicted speed for a given pixel ID 336, a future date 334 and an hour in a twenty-four hour day. The future date 334 includes a month 330 out of a twelve month calendar and a day of the week out of a seven day week.

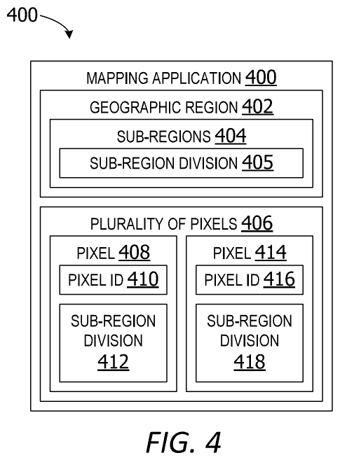

Referring now to FIG. 4, an example block diagram illustrating a mapping application 400 for generating more accurate travel time predictions using predicted speed values at a WHP level is depicted. The mapping application 400 is an application for generating mapping data, such as, but not limited to, a mapping application 128 in FIG. 1 and/or the mapping application 216 in FIG. 2. The mapping application 400 determines a distance between two points in a geographic region 402 sub-divided into a plurality of sub-regions 404. Each sub-region division 405 in the plurality of sub-regions 404 is represented by a pixel in a plurality of pixels 406. For example, a first pixel 408 having a unique pixel ID 410 represents a first sub-region division 412 in the plurality of sub-regions 404. A second pixel 414 having a different unique pixel ID 416 represents a second sub-region division 418 in the plurality of sub-regions 404. The mapping application 400, in some embodiments, calculates the distance between two nodes within one or more pixels. The mapping application utilizes the speed for each pixel on a given day of the week and hour of the day to calculate the amount of time it is likely to take a vehicle to traverse the distance between the two nodes.

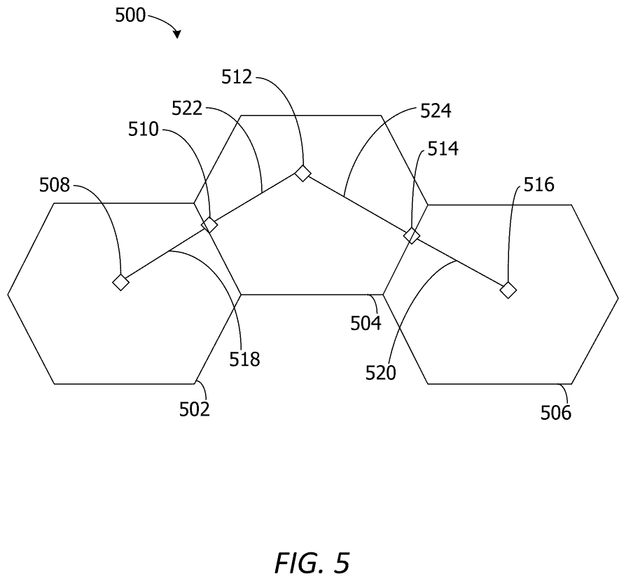

FIG. 5 depicts an example block diagram illustrating a route 500 comprising a plurality of nodes through a plurality of pixels. In this example, the route 500 passes through three pixels, a first pixel 502, a second pixel 504, and a third pixel 506. The route 500 includes a first node 508, a second node 510, a third node 512, a fourth node 514, and a fifth node 516. Each pair of nodes defines a road segment or portion of a pathway. A road segment is optionally assigned a way ID to identify each unique road segment. For example, the road segment 518 between node 508 and 510 is assigned a first unique way ID and a second road segment 520 between the fourth node 514 and the fifth node 516 is assigned a second unique way ID.

The plurality of pixels in this example includes three pixels. However, the embodiments are not limited to three pixels. In other embodiments, the plurality of pixels can include two pixels or four or more pixels. Likewise, in this example, the plurality of nodes associated with the route 500 includes five nodes. However, a route is not limited to having five nodes. A route can include any number of nodes. In other embodiments, the route 500 includes two nodes, three nodes, four nodes, as well as six or more nodes.

The system calculates a predicted speed for each pixel at each hour of each day in a given future week or future month of a year. In one example, for a Monday in the month of November at seven o'clock in the morning, the system generates a first predicted speed for the first pixel 502, a second speed for the second pixel 504, and a third predicted speed for the third pixel 506. For example, the predicted speed on Monday at seven o'clock in the morning in November can include a twenty miles per hour speed for the first road segment 518, a predicted speed of twenty-five miles per hour for the second road segment 522 and the third road segment 524 through the second pixel, and a predicted speed of thirty miles per hour for the fourth road segment 520 through the third pixel. These predicted speeds can be different at different hours of the day on the same Monday. The predicted speeds can also be different on different days of the week or different months of the year.

The techniques described herein utilize historical driver data for pixel areas at various points in time (days of the week/hour) and forecast the speed. This predicted speed can then be utilized as a standard speed measurement for all the potential routes within the same pixel, enabling the calculation of estimated travel time.

In another example, the predicted speed for the first pixel 502 can be fifty mph, the predicted speed for second pixel 504 can be twenty mph, and the predicted speed for the third pixel 506 can be fifteen mph at the same hour on the same day. If the projected journey from store to a customer location at eight o'clock in the morning travels through these three pixels (nodes A-B-C-D-E), the travel time for the entire journey can be calculated using the distances between nodes and the predicted speed values with greater accuracy.

FIG. 6 is an example flow chart illustrating operation of the computing device to use predicted future speed values at a pixel-level and estimated times of arrival (ETAs) to plan trips. The process 600 shown in FIG. 6 is performed by a customized returns manager component, executing on a computing device, such as the computing device 102 or the user device 116 in FIG. 1.

The process begins by generating travel data at a predetermined time interval (e.g., thirty seconds) at 602. The travel data is generated by computing devices associated with vehicles, such as, but not limited to, the computing device(s) 120 associated with the vehicle(s) 122 in FIG. 1. However, the embodiments are not limited to obtaining the raw travel data at thirty second intervals. In other embodiments, the travel data can be obtained at different time intervals. For example, travel data can be obtained at one minute intervals, five minute intervals, forty-five second intervals, or any other time interval.

Historical data is read and predicted speeds are predicted for pixels and road segments at a day and hour level at 604. The historical data is data associated with travel through one or more pixels, such as, but not limited to, the historical travel-related data 134 in FIG. 1. The speed values are fed into a mapping application in a monthly cadence at 606. However, the embodiments are not limited to a monthly cadence. In other embodiments, the speed values can be provided in a weekly cadence, a bi-monthly cadence, or any other cadence.

The speed values are leveraged for providing ETA between a source and destination at 608. A source is a point of departure. The source can include a store, distribution center, or other item fulfillment center. A destination can optionally include a customer residence or other delivery location for an order. A trip planner application uses the source-to-destination ETAs to plan trips at 610. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an example flow chart illustrating operation of the computing device to generate predicted speed values at a WHP level using historical travel-related data for a geographic region. The process 700 shown in FIG. 7 is performed by a customized returns manager component, executing on a computing device, such as the computing device 102 or the user device 116 in FIG. 1.

The process begins by obtaining historical travel-related data for a geographic region at 702. A speed value is generated at a weekday-hour-pixel (WHP) level for future date(s) at 704. The table is a database table, such as, but not limited to, the speed values table 136 in FIG. 1 and the speed values table 202 in FIG. 2. A speed values table is created at 706. The generated speed values are stored in the table at 708. A determination is made whether to update the table at 710. If not, the process terminates thereafter. If a determination is made to update the table, the travel data manager 150 obtains updated historical travel-related data at 712. The process iteratively executes operations 704 through 712 until a determination is made not to update the table. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

FIG. 8 is an example flow chart illustrating operation of the computing device to generate historical travel-related data from raw travel data. The process 800 shown in FIG. 8 is performed by a customized returns manager component, executing on a computing device, such as the computing device 102 or the user device 116 in FIG. 1.

The process begins by obtaining raw data for vehicle speeds at 802. The raw data includes travel-related data obtained from an application running on a computing device, such as, but not limited to, the one or more computing device(s) 120 associated with one or more vehicle(s) 122 in FIG. 1. The data is tagged to a pixel based on location data at 804. The location data is data associated with a location of a vehicle when the vehicle is pinged for the raw data, such as, but not limited to, the location data 138 in FIG. 1. The distance and time is calculated at each interval at 806. The interval is a time interval at which the raw data is obtained. In some embodiments, the raw data is obtained at thirty second intervals. However, the raw data can be obtained at any user-configurable interval. The time is the day and time at which the raw data is generated. The travel data is updated and stored at 808. The data is stored as historical travel-related data in a data storage device, such as, but not limited to, the data storage device 152 in FIG. 1. Outliers are removed from the data at 810. Future speed predictions are generated at a month-weekday-hour-pixel level at 812. The future speed predictions are made using the stored historical travel-related data. The predicted future speed values are stored in a table at 814. The table is a data table, such as, but not limited to, the speed values table 136 in FIG. 1 and/or the speed values table 202 in FIG. 2. A determination is made whether a next batch of raw data is available at 816. If yes, the system iteratively executes operations 802 through 816. If not, the process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

Turning now to FIG. 9, an example flow chart illustrating operation of the computing device to aggregating and filtering historical travel-related data is shown. The process 900 shown in FIG. 9 is performed by a customized returns manager component, executing on a computing device, such as the computing device 102 or the user device 116 in FIG. 1.

The process begins by collecting travel-related data at predetermined interval(s) at 902. The data is aggregated at 904. The data is filtered at 906. A determination is made whether to format the data at 908. If yes, the data is formatted at 910. The data is stored at 912. The data is stored in a database or other data storage, such as, but not limited to, the data storage device 152 in FIG. 1. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

FIG. 10 is an example flow chart illustrating operation of the computing device to filter raw travel-related data obtained from a plurality of vehicles. The process 1000 shown in FIG. 10 is performed by a customized returns manager component, executing on a computing device, such as the computing device 102 or the user device 116 in FIG. 1.

The process begins by receiving travel-related data at 1002. Source and destination proximity data is excluded at 1004. Proximity data includes vehicle speed data obtained at locations within a threshold distance from a point of departure or a threshold distance from a destination. Data with a maximum speed value that is less than or equal to a speed limit is retained at 1006. Speed data exceeding a posted speed limit for a road segment is removed. Other outliers are filtered at 1008. The filtered data is stored at 1010. The data is stored as historical travel-related data. The process terminates thereafter.

While the operations illustrated in FIG. 10 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 10.

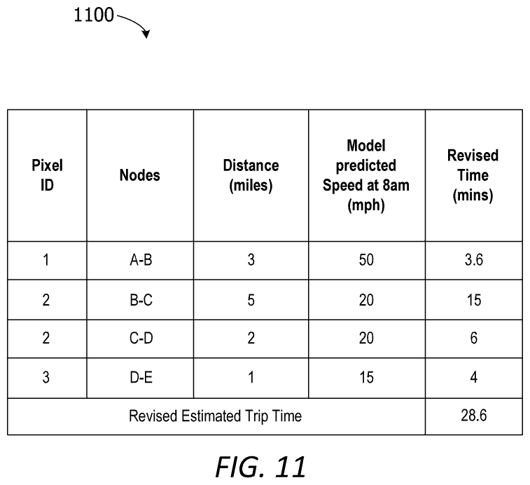

FIG. 11 depicts an example of a table 1100 of predicted speed values and estimated travel times for a plurality of road segments associated with a plurality of pixels representing portions of a geographic region. The table 1100 includes distance and predicted speeds for road segments and nodes associated with a route. In this example, a first pixel includes a road segment between a node A and a node B that is three miles long with a predicted speed of fifty miles per hour. A revised time for a vehicle to traverse the road segment is 3.6 minutes. A second road segment between the node B and a node C associated with a second pixel is five miles long with a predicted speed value of twenty miles per hour. The revised travel time estimate for this second road segment is fifteen minutes. In this example, the estimated travel time to travel the route from a point of departure at node A to a destination at node E is approximately twenty-eight point six minutes in total. This is a more accurate predicted travel time for this route than could be generated using static data, such as posted speed limits or generic travel time data which is not generated at a month, weekday, hour, and pixel level.

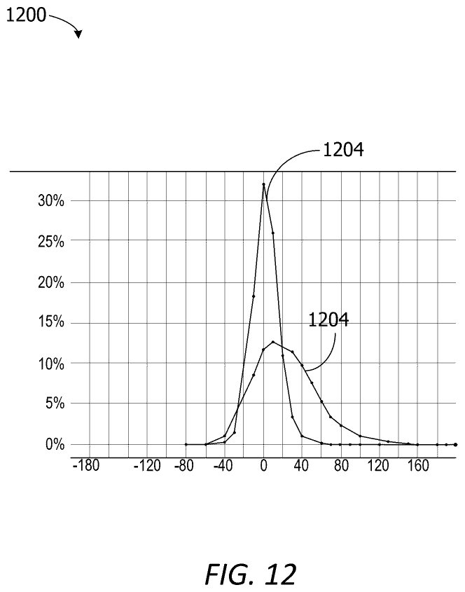

FIG. 12 depicts an example of a line graph 1200 representing travel time accuracy using predicted speed values at a WHP level versus travel time accuracy using static average speed values. Having an accurate estimation of driving time allows improved trip planning for timely delivery of orders. On-time delivery (OTD) metric measures the percentage of orders that were successfully delivered to customers within the promised timeframe. In this example, travel time estimates using static data shown at 1202 is less accurate than travel time estimates generated using predicted speed at a MWHP level shown at line 1204. In other words, the ETAs generated using the speed values at the MWHP level results in a greater number of on-time deliveries than the ETAs generated using traditional, static speed estimates. This further indicates an increase in overall arrival time accuracy as a result of generating and employing travel-related data at a finer granularity.

### Additional Examples

The system, in some embodiments, is a trained forecasting model for predicting accurate pixel-specific travel times at a day and hour level of granularity used to predict travel time. A planner system calculates the estimated time of arrival (ETA) of a trip. The system obtains driver locations as pings every 30 seconds and with this data, the system tracks the speed trucks are travelling at. The system calculates speeds at a month, day of week, and hour level. We will map the core based statistical areas (CBSAs) in to set of H8 Uber pixels and calculate speeds at Month, day of week and hour level so that we know on which day and at what time what the speed is.

The system provides a forecasting model trained to predict speed. Predicted speed is used to calculate more accurate ETA of a trip to improve OTD. A pipeline is provided to ingest delivery vehicle location pings and calculate speed at every H8 pixel in a given region. A predictive machine learning model is trained on the historical data to predict speed for a given year, month, day, hour and pixel. Predicted speed at pixels are used to determine the speed of a given way-id (road segment/pixel ID/node) in a base map. The predictions are utilized by a mapping application to have speed for each way-id for given year, month, day, and hour. This enhances the existing mapping application programming interface (API) to calculate the distance and time between two location with predicted speed in consideration. This enhances the trip planner to calculate trip time with predicted speed in consideration. The system is scalable, which makes existing last mile trip planning traffic aware for more efficient and cost-effective order batches, routes, and trips. This further reduces the gap between predicted and actual trip time and achieve accuracy of over ninety-five percent where previous systems had accuracy of only seventy to eighty percent.

In other embodiments, delivery vehicle location data is obtained as pings every 30 seconds. This data is used to determine the speed that the vehicles are moving at each location. The data is mapped to pixels and used to calculate speeds at a month, day of week and hour level informing the system as to the speed at specific days and time.

In some examples, the system includes a Machine Learning (ML) model which estimates travel time based on the historical travel data of delivery drivers and other geographical parameters in a scalable manner for more accurate travel time predictions and an increased rate of on-time deliveries.

In some embodiments, the real-time location (based on GPS location) of drivers is captured by the last mile data collection system and sent over a network every thirty seconds (approximately 200M records/day). These captured events contain precise information about a delivery vehicle's current location, trip ID, distance to be traveled, timestamps identifying a time of day when the data is generated, pixel ID, speed (after filtering and/or transformation). The events, in some embodiments, are stored in a JSON format in a specific location in a cloud storage. The raw data is retained for a given period of time, such as, but not limited to, 180 days.

In some embodiments, the system filters raw travel-related data to exclude data points where the delivery vehicle has not moved more than 100 meters for a threshold time, such as, but not limited to, a fifteen minute maximum threshold time without movement. In other embodiments, the system identifies and excludes wait times at stores and other fulfillment centers where orders are picked up, as they have the potential to distort the data interpretation and travel time predictions. In other embodiments, proximity data near destinations and source locations (point of departure) are excluded because vehicles tend to slow down or stop within a 200-meter radius of stores and within a 100-meter radius of customer locations. These data points are not considered for traffic pattern analysis to prevent outliers from distorting results.

The system, in other embodiments, generate a predicted speed for a given pixel-timeslot using data, such as, but not limited to, pixel ID (identifies a specific geographic position), month of the year, day of the week, and hour of the day. To avoid over or under estimation, various aggregation is employed to calculate the speed of a pixel, considering that there can be multiple drivers driving at different speeds within the same pixel. Likewise, where historical travel-related data for a particular pixel is absent, the system utilizes data for adjacent pixels (nearest neighbor) to generate predicted speed values for the pixel's without the historical travel-related data. Outliers are managed by applying thresholds for time, distance, and speed, considering the legal speed limits for each road or road segment.

This machine learning approach surpasses other heuristic techniques in several aspects. It offers faster computation and updating speeds on a larger scale. It can learn and implement traffic patterns at various times of the day and in diverse geographical regions. Furthermore, it can predict the speed of any new pixel ID, even without its data being present in historical training dataset. In this manner, the system is scalable enabling expansion to include larger geographic regions.

The ML forecasting model is trained on historical travel-related data to predict the speed at each pixel which is further integrated with a mapping application. Using the speed details, a trip planner is able to calculate the ETA of a trip to improve OTD. The mapping application is a routing engine designed to find the fastest or shortest route between two points on a map.

Other embodiments provide a traffic pattern recognition and prediction system for effective planning of online deliveries. The system is a trained forecasting model for predicting a speed. The system calculates an ETA for a trip. The system obtains vehicle locations as pings every few seconds (such as 30 seconds) for tracking the speed (i.e., speed at which trucks are traveling.) The system calculates speeds at a month, day of week, hour, year, and/or pixel level using a predictive machine learning model (which is trained on the historical data). The system maps core-based statistical areas (CBSAs) into a set of H8 uber pixels and calculates speeds at month, day of week, and hour level (to know on which day at what time, what is the speed). The system uses the predicted speed at pixels to determine the speed of a given way-id in a mapping application base map. The system integrates the prediction with the mapping application to have speed for each way-id for given year, month, day, and hour. The system calculates the distance and time between two locations with predicted speed in consideration (to enhance existing mapping application API).

In an example scenario, where three drivers pass through Pixel ID A, covering distances (in miles) of 2, 3, and 4, and taking times (in minutes) of 3, 4, and 5, respectively. Their resultant speeds (in mph) would be 40, 45, and 48. The speed value for Pixel ID A is therefore calculated as the sum of the distances divided by the sum of the times, which equals 45 mph. This is different from calculating the average of all the speeds, which would be 44.3 mph.

Alternatively, or in addition to the other examples described herein, examples include any combination of the following:
train the ML model using the historical travel-related data to predict a future speed of a vehicle traveling along a road segment within a selected pixel on a selected day of a week within a selected month and within a specific hour on the selected day of the week within the selected month based on historical speeds of a plurality of vehicles traveling along the road segment on a same day of the week during a same hour of the day of the week within previous months;
forecast a speed through each pixel in the plurality of pixels at a month-weekday-hour-pixel (MWHP) level;
filter the historical travel-related data to remove outlier speed values, the outlier speed values comprising speed values exceeding a speed limit for a given node, speed values falling below a threshold minimum speed for a given node, and speed values associated with vehicles remaining stationary for a threshold time;
filter the historical travel-related data to remove speed values associated with vehicles within a threshold distance from a point of departure and vehicles within a threshold distance from a destination;
select a speed value from the speed values table associated with a selected pixel identifier (ID) associated with a pixel in the plurality of pixels for a given future date and within a given hour on the given future date;
identify a node within a plurality of nodes associated with the pixel ID;
calculate a predicted travel time to traverse the node on the given future date using the selected speed value, wherein an accurate estimated time of arrival is generated using the predicted travel time;
identify a plurality of nodes associated with a first pixel and a second pixel corresponding to a candidate route from the point of departure to the destination;
select a first speed value from the speed values table associated with a first pixel identifier (ID) of the first pixel at a selected month, weekday, and hour;
select a second speed value from the speed values table associated with a second pixel ID of the second pixel at the selected month, the weekday, and the hour;
calculate a predicted travel time to traverse the plurality of nodes on the selected month, the weekday, and the hour using the selected first speed value and the selected second speed value, wherein an accurate estimated time of arrival (ETA) is generated using the predicted travel time;
obtaining historical travel-related data associated with a plurality of vehicles traveling within a geographic region, the historical travel-related data comprising location data and speed data associated with each pixel in a plurality of pixels at a month, day, and hour level, wherein each pixel in the plurality of pixels represents a unique sub-region division of the geographic region;
generating a speed value at a weekday-hour-pixel (WHP) level for each pixel in the plurality of pixels, by a trained machine learning (ML) model using the historical travel-related data, wherein the ML model is trained to generate a predicted speed of travel through the plurality of pixels at the month, day, and hour level;
creating a speed values table comprising a plurality of pixel-timeslot speed values for a plurality of future dates, a pixel-timeslot speed value in the plurality of pixel-timeslot speed values comprising a predicted speed of travel along a node through a selected pixel at a future date and within a selected hour of the future date;
storing the speed values table in a data storage device, wherein speed values in the speed values table are utilized by a mapping application to predict speeds to traverse a plurality of nodes between a point of departure and a destination at WHP level;
training the ML model using the historical travel-related data to predict a future speed of a vehicle traveling along a road segment within a selected pixel on a selected day of a week within a selected month and within a specific hour on the selected day of the week within the selected month based on historical speeds of a plurality of vehicles traveling along the road segment on a same day of the week during a same hour of the day of the week within previous months;
forecasting a speed through each pixel in the plurality of pixels at a month-weekday-hour-pixel (MWHP) level;
filtering the historical travel-related data to remove outlier speed values, the outlier speed values comprising speed values exceeding a speed limit for a given node, speed values falling below a threshold minimum speed for a given node, and speed values associated with vehicles remaining stationary for a threshold time;
filtering the historical travel-related data to remove speed values associated with vehicles within a threshold distance from a point of departure and vehicles within a threshold distance from a destination;
selecting a speed value from the speed values table associated with a selected pixel identifier (ID) associated with a pixel in the plurality of pixels for a given future date and within a given hour on the given future date;
identifying a node within a plurality of nodes associated with the pixel ID;
calculating a predicted travel time to traverse the node on the given future date using the selected speed value, wherein an accurate estimated time of arrival is generated using the predicted travel time;
identifying a plurality of nodes associated with a first pixel and a second pixel corresponding to a candidate route from the point of departure to the destination;
selecting a first speed value from the speed values table associated with a first pixel identifier (ID) of the first pixel at a selected month, weekday, and hour;
selecting a second speed value from the speed values table associated with a second pixel ID of the second pixel at the selected month, the weekday, and the hour;
calculating a predicted travel time to traverse the plurality of nodes on the selected month, the weekday, and the hour using the selected first speed value and the selected second speed value, wherein an accurate estimated time of arrival (ETA) is generated using the predicted travel time.

At least a portion of the functionality of the various elements in FIG. 1, FIG. 2, FIG. 3, and FIG. 4 can be performed by other elements in FIG. 1, FIG. 2, FIG. 3, and FIG. 4, or an entity (e.g., processor 106, web service, server, application program, computing device, etc.) not shown in FIG. 1, FIG. 2, FIG. 3, and FIG. 4.

In some examples, the operations illustrated in FIG. 6, FIG. 7, FIG. 8, FIG. 9, and FIG. 10 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of generating accurate speed predictions at a WHP level, the method comprising obtaining historical travel-related data associated with a plurality of vehicles traveling within a geographic region, the historical travel-related data comprising location data and speed data associated with each pixel in a plurality of pixels at a month, day, and hour level, wherein each pixel in the plurality of pixels represents a unique sub-region division of the geographic region; generating an speed value at a weekday-hour-pixel (WHP) level for each pixel in the plurality of pixels, by a trained machine learning (ML) model using the historical travel-related data, wherein the ML model is trained to generate a predicted speed of travel through the plurality of pixels at the month, day, and hour level; creating a speed values table comprising a plurality of pixel-timeslot speed values for a plurality of future dates, a pixel-timeslot speed value in the plurality of pixel-timeslot speed values comprising a predicted speed of travel along a node through a selected pixel at a future date and within a selected hour of the future date; and storing the speed values table in a data storage device, wherein speed values in the speed values table are utilized by a mapping application to predict speeds to traverse a plurality of nodes between a point of departure and a destination at WHP level.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to travel data monitored and/or collected from the users and/or vehicles. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Example Operating Environment

Example computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Example computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an example computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute example means for generating accurate predicted speed values at a WHP level. For example, the elements illustrated in FIG. 1, FIG. 2, FIG. 3, and FIG. 4, such as when encoded to perform the operations illustrated in FIG. 6, FIG. 7, FIG. 8, FIG. 9, and FIG. 10, constitute example means for receiving historical travel-related data associated with a plurality of vehicles traveling within a geographic region, the historical travel-related data comprising location data and speed data associated with each pixel in a plurality of pixels at a month, day, and hour level, each pixel representing a unique sub-region division of the geographic region; example means for generating a speed value at a weekday-hour-pixel (WHP) level for each pixel in the plurality of pixels, by a trained machine learning (ML) model using the historical travel-related data, wherein the ML model is trained to generate a predicted speed of travel through the plurality of pixels at the month, day, and hour level; example means for creating a speed values table comprising a plurality of pixel-timeslot speed values for a plurality of future dates, a pixel-timeslot speed value in the plurality of pixel-timeslot speed values comprising a predicted speed of travel along a node through a selected pixel at a future date and within a selected hour of the future date; and example means for storing the speed values table in a data storage device, wherein speed values in the speed values table are utilized by a mapping application to predict speeds to traverse a plurality of nodes between a point of departure and a destination at WHP level.

Other non-limiting examples provide one or more computer storage devices having a first computer-executable instructions stored thereon for providing future speed values at a WHP level for more accurate travel time estimations. When executed by a computer, the computer performs operations including obtaining historical travel-related data associated with a plurality of vehicles traveling within a geographic region, the historical travel-related data comprising location data and speed data associated with each pixel in a plurality of pixels at a month, day, and hour level, wherein each pixel in the plurality of pixels represents a unique sub-region division of the geographic region; generating an value at a weekday-hour-pixel (WHP) level for each pixel in the plurality of pixels, by a trained machine learning (ML) model using the historical travel-related data, wherein the ML model is trained to generate a predicted speed of travel through the plurality of pixels at the month, day, and hour level; creating a speed values table comprising a plurality of pixel-timeslot speed values for a plurality of future dates, a pixel-timeslot speed value in the plurality of pixel-timeslot speed values comprising a predicted speed of travel along a node through a selected pixel at a future date and within a selected hour of the future date; and storing the speed values table in a data storage device, wherein speed values in the speed values table are utilized by a mapping application to predict speeds to traverse a plurality of nodes between a point of departure and a destination at WHP level.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for generating accurate pixel-specific travel time, the system comprising:
a processor; and
a computer-readable medium storing instructions that are operative upon execution by the processor to:
obtain historical travel-related data associated with a plurality of vehicles traveling within a geographic region, the historical travel-related data comprising location data and speed data associated with each pixel in a plurality of pixels at a month, day, and hour level, each pixel representing a unique sub-region division of the geographic region;
generate a speed value at a weekday-hour-pixel (WHP) level for each pixel in the plurality of pixels, by a trained machine learning (ML) model using the historical travel-related data, wherein the ML model is trained to generate a predicted speed of travel through the plurality of pixels at the month, day, and hour level;
create a speed values table comprising a plurality of pixel-timeslot speed values for a plurality of future dates, a pixel-timeslot speed value in the plurality of pixel-timeslot speed values comprising a predicted speed of travel along a node through a selected pixel at a future date and within a selected hour of the future date; and
store the speed values table in a data storage device, wherein speed values in the speed values table are utilized by a mapping application to predict speeds to traverse a plurality of nodes between a point of departure and a destination at WHP level.

2. The system of claim 1, wherein the instructions are further operative to:
train the ML model using the historical travel-related data to predict a future speed of a vehicle traveling along a road segment within a selected pixel on a selected day of a week within a selected month and within a specific hour on the selected day of the week within the selected month based on historical speeds of a plurality of vehicles traveling along the road segment on a same day of the week during a same hour of the day of the week within previous months.

3. The system of claim 1, wherein the instructions are further operative to:
forecast a speed through each pixel in the plurality of pixels at a month-weekday-hour-pixel (MWHP) level.

4. The system of claim 1, wherein the instructions are further operative to:
filter the historical travel-related data to remove outlier speed values, the outlier speed values comprising speed values exceeding a speed limit for a given node, speed values falling below a threshold minimum speed for a given node, and speed values associated with vehicles remaining stationary for a threshold time.

5. The system of claim 1, wherein the instructions are further operative to:
filter the historical travel-related data to remove speed values associated with vehicles within a threshold distance from a point of departure and vehicles within a threshold distance from a destination.

6. The system of claim 1, wherein the instructions are further operative to:
select a speed value from the speed values table associated with a selected pixel identifier (ID) associated with a pixel in the plurality of pixels for a given future date and within a given hour on the given future date;
identify a node within a plurality of nodes associated with the pixel ID; and
calculate a predicted travel time to traverse the node on the given future date using the selected speed value, wherein an accurate estimated time of arrival is generated using the predicted travel time.

7. The system of claim 1, wherein the instructions are further operative to:
identify a plurality of nodes associated with a first pixel and a second pixel corresponding to a candidate route from the point of departure to the destination;
select a first speed value from the speed values table associated with a first pixel identifier (ID) of the first pixel at a selected month, weekday, and hour;
select a second speed value from the speed values table associated with a second pixel ID of the second pixel at the selected month, the weekday, and the hour; and
calculate a predicted travel time to traverse the plurality of nodes on the selected month, the weekday, and the hour using the selected first speed value and the selected second speed value, wherein an accurate estimated time of arrival (ETA) is generated using the predicted travel time.

8. A method for generating accurate pixel-specific travel time, the method comprising:
obtaining historical travel-related data associated with a plurality of vehicles traveling within a geographic region, the historical travel-related data comprising location data and speed data associated with each pixel in a plurality of pixels at a month, day, and hour level, wherein each pixel in the plurality of pixels represents a unique sub-region division of the geographic region;
generating a speed value at a weekday-hour-pixel (WHP) level for each pixel in the plurality of pixels, by a trained machine learning (ML) model using the historical travel-related data, wherein the ML model is trained to generate a predicted speed of travel through the plurality of pixels at the month, day, and hour level;
creating a speed values table comprising a plurality of pixel-timeslot speed values for a plurality of future dates, a pixel-timeslot speed value in the plurality of pixel-timeslot speed values comprising a predicted speed of travel along a node through a selected pixel at a future date and within a selected hour of the future date; and
storing the speed values table in a data storage device, wherein speed values in the speed values table are utilized by a mapping application to predict speeds to traverse a plurality of nodes between a point of departure and a destination at WHP level.

9. The method of claim 8, further comprising:
training the ML model using the historical travel-related data to predict a future speed of a vehicle traveling along a road segment within a selected pixel on a selected day of a week within a selected month and within a specific hour on the selected day of the week within the selected month based on historical speeds of a plurality of vehicles traveling along the road segment on a same day of the week during a same hour of the day of the week within previous months.

10. The method of claim 8, further comprising:
forecasting a speed through each pixel in the plurality of pixels at a month-weekday-hour-pixel (MWHP) level.

11. The method of claim 8, further comprising:
filtering the historical travel-related data to remove outlier speed values, the outlier speed values comprising speed values exceeding a speed limit for a given node, speed values falling below a threshold minimum speed for a given node, and speed values associated with vehicles remaining stationary for a threshold time.

12. The method of claim 8, further comprising:
filtering the historical travel-related data to remove speed values associated with vehicles within a threshold distance from a point of departure and vehicles within a threshold distance from a destination.

13. The method of claim 8, further comprising:
selecting a speed value from the speed values table associated with a selected pixel identifier (ID) associated with a pixel in the plurality of pixels for a given future date and within a given hour on the given future date;
identifying a node within a plurality of nodes associated with the pixel ID; and
calculating a predicted travel time to traverse the node on the given future date using the selected speed value, wherein an accurate estimated time of arrival is generated using the predicted travel time.

14. The method of claim 8, further comprising:
identifying a plurality of nodes associated with a first pixel and a second pixel corresponding to a candidate route from the point of departure to the destination;
selecting a first speed value from the speed values table associated with a first pixel identifier (ID) of the first pixel at a selected month, weekday, and hour;
selecting a second speed value from the speed values table associated with a second pixel ID of the second pixel at the selected month, the weekday, and the hour; and
calculating a predicted travel time to traverse the plurality of nodes on the selected month, the weekday, and the hour using the selected first speed value and the selected second speed value, wherein an accurate estimated time of arrival (ETA) is generated using the predicted travel time.

15. One or more computer storage devices having computer-executable instructions stored thereon, which, upon execution by a computer, cause the computer to perform operations comprising:
receiving historical travel-related data associated with a plurality of vehicles traveling within a geographic region, the historical travel-related data comprising location data and speed data associated with each pixel in a plurality of pixels at a month, day, and hour level, each pixel representing a unique sub-region division of the geographic region;
generating a speed value at a weekday-hour-pixel (WHP) level for each pixel in the plurality of pixels, by a trained machine learning (ML) model using the historical travel-related data, wherein the ML model is trained to generate a predicted speed of travel through the plurality of pixels at the month, day, and hour level;
creating a speed values table comprising a plurality of pixel-timeslot speed values for a plurality of future dates, a pixel-timeslot speed value in the plurality of pixel-timeslot speed values comprising a predicted speed of travel along a node through a selected pixel at a future date and within a selected hour of the future date; and
storing the speed values table in a data storage device, wherein speed values in the speed values table are utilized to predict speeds to traverse a plurality of nodes between a point of departure and a destination at WHP level.

16. The one or more computer storage devices of claim 15, wherein the operations further comprise:
training the ML model using the historical travel-related data to predict a future speed of a vehicle traveling along a road segment within a selected pixel on a selected day of a week within a selected month and within a specific hour on the selected day of the week within the selected month based on historical speeds of a plurality of vehicles traveling along the road segment on a same day of the week during a same hour of the day of the week within previous months.

17. The one or more computer storage devices of claim 15, wherein the operations further comprise:
forecasting a speed through each pixel in the plurality of pixels at a month-weekday-hour-pixel (MWHP) level.

18. The one or more computer storage devices of claim 15, wherein the operations further comprise:
filtering the historical travel-related data to remove outlier speed values, the outlier speed values comprising speed values exceeding a speed limit for a given node, speed values falling below a threshold minimum speed for a given node, and speed values associated with vehicles remaining stationary for a threshold time.

19. The one or more computer storage devices of claim 15, wherein the operations further comprise:
filtering the historical travel-related data to remove speed values associated with vehicles within a threshold distance from a point of departure and vehicles within a threshold distance from a destination.

20. The one or more computer storage devices of claim 15, wherein the operations further comprise:
selecting a speed value from the speed values table associated with a selected pixel identifier (ID) associated with a pixel in the plurality of pixels for a given future date and within a given hour on the given future date;
identifying a node within a plurality of nodes associated with the pixel ID; and
calculating a predicted travel time to traverse the node on the given future date using the selected speed value, wherein an accurate estimated time of arrival is generated using the predicted travel time.
